(19) United States
(12) Patent Application Publication
(10) Pub. No.: US 2012/0024932 A1
(43) Pub. Date: Feb. 2, 2012

(54) TOOL

(75) Inventor: Andras D. HAASZ, Bristol (GB)

(73) Assignee: ROLLS-ROYCE PLC, London (GB)

(21) Appl. No.: 13/182,033

(22) Filed: Jul. 13, 2011

(30) Foreign Application Priority Data
Jul. 27, 2010 (GB) 1012507.8
Jul. 13, 2011 (GB) 1111958.3

(51) Int. Cl. B25C 1/06

(52) U.S. Cl. 227/131; 227/120

(57) ABSTRACT

A tool for applying retaining elements in the form of a pins made from a shape memory effect material to a workpiece includes a body having a discharge passage for the pins, and application means in the form of a solenoid for ejecting pins from the discharge passage. Pins for application are accommodated in a magazine which has a region maintained at lower than ambient temperature by cooling elements. At the cold temperature, the pins are generally straight. Upon heating after application to the workpiece, the pins assume a second memorised configuration in which they are retained within the workpiece. The tool includes a display screen for displaying a count of pins discharged by the solenoid and the temperature maintained by the cooling elements.

This invention relates to a tool for applying a retaining element made from a shape memory effect material, and to a method of applying such a retaining element.

It is known to use a split pin, or cotter pin, as a retaining element to retain first and second components together, for example to retain a clevis pin against axial displacement within a retaining ring. The cotter pin is inserted through aligned holes in the retaining ring and the clevis pin, and the protruding tangs are bent outwardly from each other to prevent withdrawal of the cotter pin. Typically, the tangs are bent fully round into close engagement with the outer surface of the retaining ring to ensure the best locking function, to minimise fretting, and to leave a neat assembly less prone to snag.

Bending the tangs requires an additional fitting operation after the pin has been inserted. Disassembly is not always easy, and can cause damage to the components.

Shape memory effect materials are known. Components made from such materials exhibit the property of returning to a predetermined “memorised” shape when their temperature changes through a transition temperature. The component may, for example, resume the memorised shape when heated from the “cold” state above the transition temperature to the “hot” state.

A known shape memory effect material is Nitinol, for which the transition temperature may fall in a range extending from below 0° C. to above 150° C. In the “cold” phase, i.e. below the transition temperature, Nitinol has a martensitic structure, whereas in the “hot” phase above the transition temperature it transforms to an austenitic structure. The memorised shape is fixed by forming the component to the desired shape and then heating it, while maintaining the shape, to an elevated temperature (for example about 500° C.). Subsequently, when the component is reduced in temperature to below its transition temperature, it transforms to the martensitic structure, in which form it has a relatively low Young's modulus and can be deformed under moderate stress. Thus, the component can be formed into a first configuration in the “cold” state. If the component is reheated to the “hot” state, above the transition temperature, it reverts to the austenitic structure and to the previously memorised shape, constituting a second configuration. The transformation results in an increased Young's modulus, so that the second shape is strongly resistant to deformation.

If the component is then cooled again, below the transition temperature, the memorised shape is normally retained unless the component is subjected to a stress sufficient to deform it. The cycle can be repeated many times, with the component reverting to its memorised shape each time it is heated above the transition temperature, even if it is deformed while in the “cold” state.

It has been proposed to employ components made from shape memory effect materials as retaining elements to hold together parts of an assembly. Thus, the component, which may be in the form of a pin, may transform between a straight configuration and a bent configuration as it is heated past the transition temperature. For example, the retaining element may assume the straight configuration at a lower than ambient temperature, and transform to the bent configuration at ambient temperature.

Consequently, the retaining element must be maintained at the lower than ambient temperature during application to the workpiece. This can cause problems if the retaining element has to be removed from an enclosure, and then applied to the workpiece before it has cooled below the transition temperature. Particular difficulties can arise if a single assembly has a large number of parts which need to be secured by means of the retaining elements, since an operator cannot easily ensure that each retaining element is at the correct temperature as it is applied to the assembly. Furthermore, it is necessary for the operator to ensure that all of the parts have been properly secured, in other words that all of the required retaining elements have been properly fitted.

According to one aspect of the present invention there is provided a tool for applying a retaining element made from a shape memory effect material, the tool comprising application means for applying the retaining element to a workpiece, and a magazine for accommodating the retaining element prior to application, the magazine being provided with temperature control means for maintaining the retaining element at a temperature within a predetermined range prior to application to the workpiece.

The temperature control means may comprise a cooling element in the magazine. The magazine may have a first region that is subject primarily to temperature control by the temperature control means.

The tool may be provided with a feed mechanism for feeding the retaining element from the magazine to the application means. The application means may comprise drive means for displacing the retaining element from the tool. The drive means may comprise a solenoid. Means may be provided for counting retaining elements as they are applied to the workpiece, for example by counting actuations of the solenoid.

A temperature sensor may be provided which is responsive to the temperature maintained in the magazine by the temperature control means. Display means may be provided for displaying the temperature measured by the sensor and/or the retaining element count.

The present invention also provides a tool in accordance with the first aspect of the invention, in which a plurality of retaining elements are accommodated within the magazine. Each retaining element may have a first configuration assumed when the retaining element is at a temperature within the temperature range maintained by the temperature control means, and a second configuration assumed when the retaining element is at a temperature outside the predetermined range. The second configuration may be assumed at ambient temperature.

The retaining element may be in the form of a pin, which is substantially straight in the first configuration and curved in the second configuration.

The tool may be a hand-held tool, and may comprise a hand-held unit comprising the application means and the magazine, and a separate monitoring unit in signal communication with the hand-held unit. If the tool comprises display means for displaying temperature and/or retaining element count, the display means may be provided on the monitoring unit. The monitoring unit may be provided with a power supply for the hand-held unit.

According to another aspect of the present invention, there is provided a method of applying a retaining element using a tool in accordance with the first aspect of the invention, the retaining element being made from a shape memory effect material, the method comprising:
(i) accommodating the retaining element in the magazine of the tool at a temperature at which the retaining element has a first configuration;
(ii) applying the retaining element to a workpiece, the workpiece being at a temperature at which the retaining element assumes a second configuration.

The temperature of the workpiece may be ambient temperature, and the temperature at which the retaining element is accommodated within the magazine may be lower than ambient temperature.

For a better understanding of the present invention, and to show more clearly how it may be carried into effect, reference will now be made, by way of example, to the accompanying drawings, in which:—

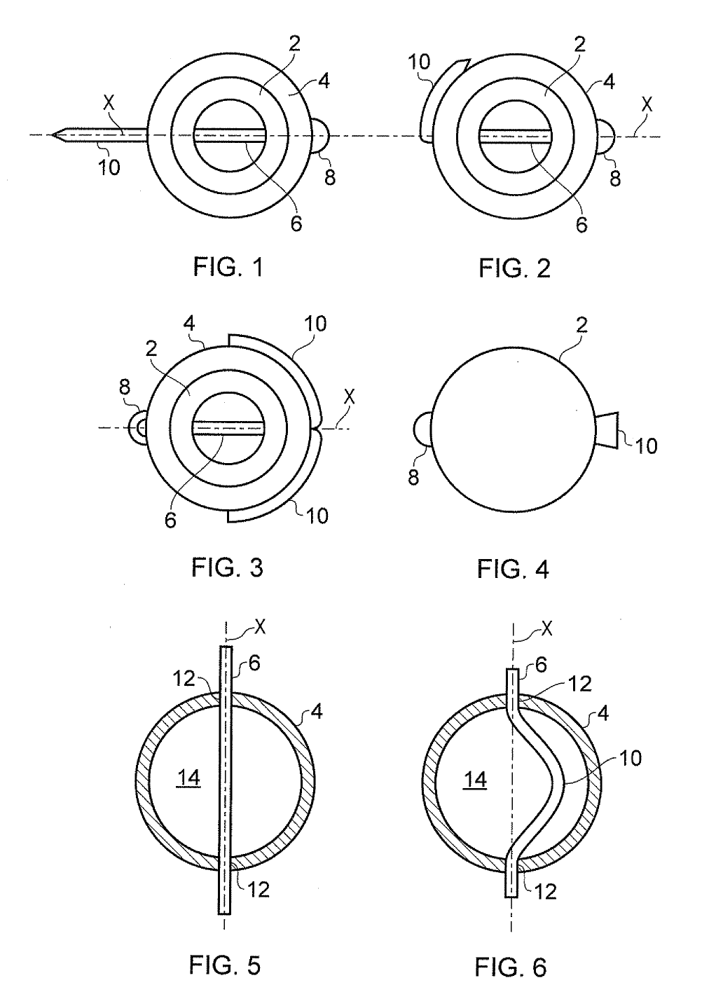

FIG. 1 show a clevis pin assembly comprising a retaining pin in a first configuration;

FIG. 2 shows the assembly of FIG. 1 with the retaining pin in a second configuration;

FIGS. 3 to 6 show variants of the assembly of FIGS. 1 and 2;

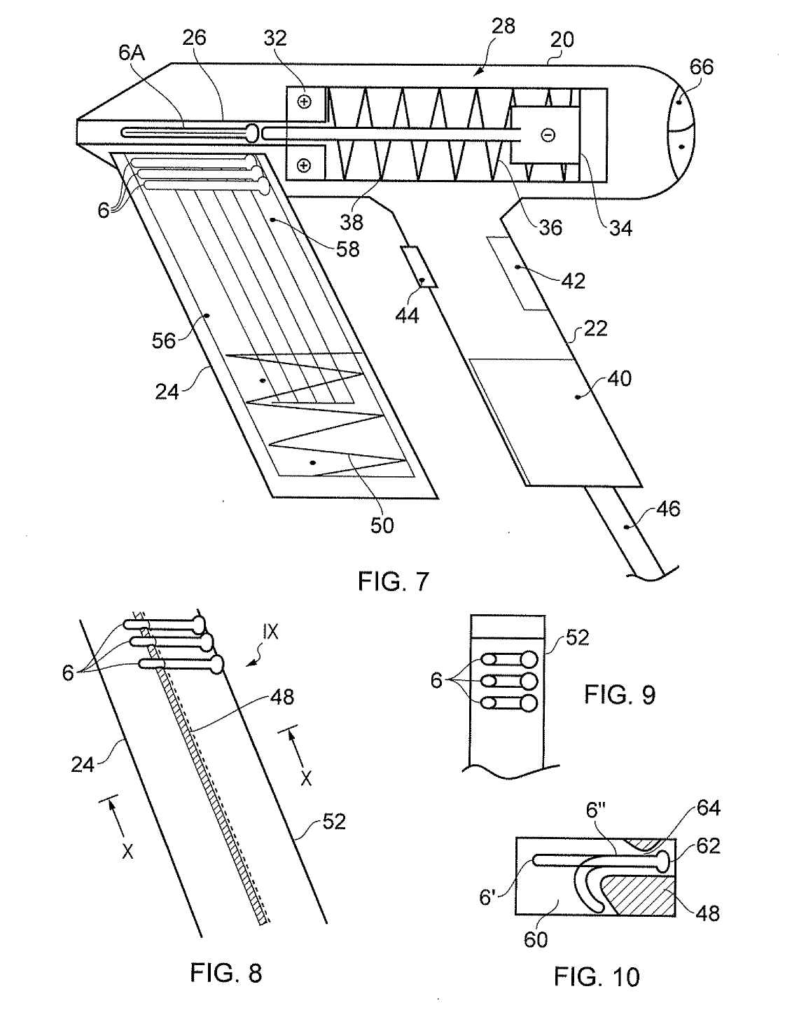

FIG. 7 is a side view of a tool for applying a retaining pin;

FIG. 8 is a schematic view of a magazine of the tool of FIG. 7;

FIG. 9 is a schematic view in the direction IX in FIG. 8 with the retaining pins in a second configuration;

FIG. 10 is a schematic view sectional view on the line X-X in FIG. 8;

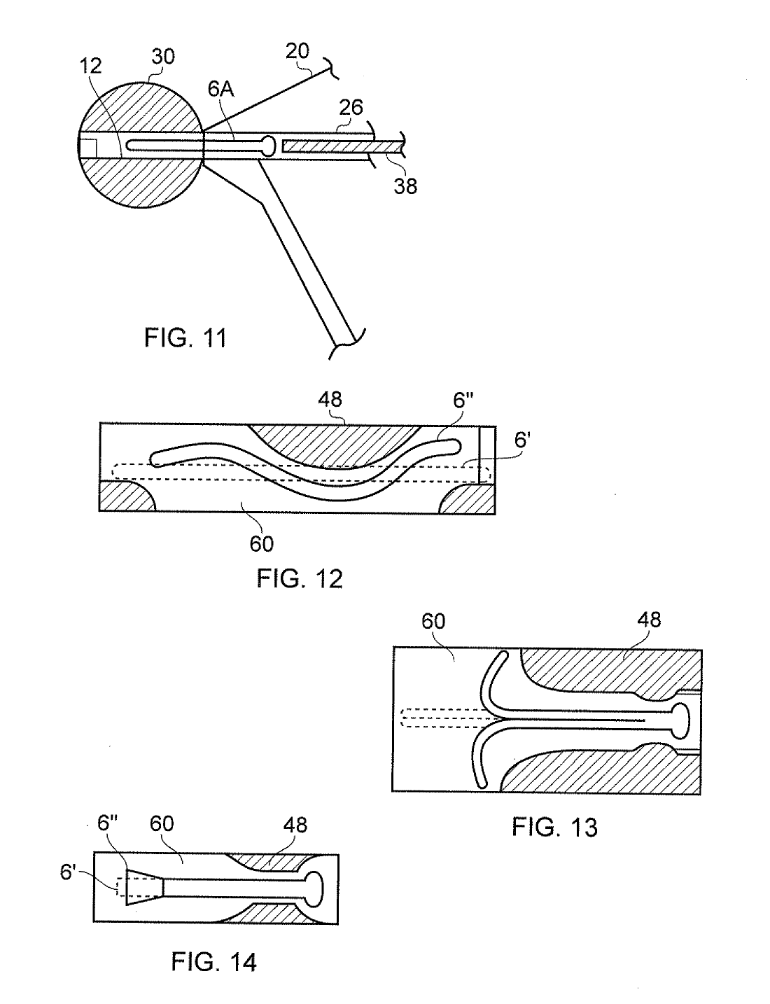

FIG. 11 represents the application of a retaining pin using the tool of FIGS. 7 to 10;

FIG. 12 corresponds to FIG. 10, but shows a magazine suitable for a retaining pin as shown in FIG. 3;

FIG. 13 corresponds to FIG. 10, but shows a magazine suitable for a retaining pin as shown in FIG. 4;

FIG. 14 corresponds to FIG. 10, but shows a magazine suitable for a retaining pin as shown in FIGS. 5 and 6;

FIG. 1 shows a clevis pin 2 supported in a clevis or retaining ring 4. Both the clevis pin 2 and the retaining ring 4 are cylindrical, with the clevis pin 2 fitted coaxially within the retaining ring 4.

Both the clevis pin 2 and the retaining ring 4 have diametrically opposite holes (not shown) which, in the assembled condition shown in FIG. 1, are aligned with each other and receive a retaining element in the form of a pin 6. The retaining pin 6 is a relatively close fit in the holes, and serves to retain the clevis pin 2 and the retaining ring 4 together.

The retaining pin 6 has a head 8 at one end and, in the condition shown in FIG. 1, projects at the other end from the retaining ring 4 as a retaining portion 10.

The entire retaining pin 8 is made from a shape memory effect material such as Nitinol, and is conditioned so as to have two memorised states. The shape memory effect is utilised to enable the retaining pin 6 to be inserted into the holes in the clevis pin 2 and the retaining ring 4 in a first configuration, achieved when the pin 6 is at a temperature within a predetermined range, at which the material of the pin 6 is in a first memorised state. In this first configuration, as shown in FIG. 1, the pin 6 has a straight longitudinal pin axis X and so can be inserted with minimum force. Subsequently, on a change in temperature of the retaining pin 6 to a temperature outside the predetermined range, the pin adopts a second configuration as shown in FIG. 2, in a second memorised state in which the retaining portion 10 is bent with respect to the longitudinal pin axis X so as to lie against the outer cylindrical surface of the retaining ring 4. In the second configuration shown in FIG. 2, the retaining portion 10 acts to prevent withdrawal of the retaining pin 6, since the orientation of the retaining portion 10 prevents it from re-entering the hole in the retaining ring 4.

To assemble the clevis pin 2 with the retaining ring 4, the clevis pin 2 is placed within the retaining ring 4, and the pin 6 is cooled so that it assumes the straight configuration shown in FIG. 1. The straight pin 6 is inserted through the aligned holes in the two components. Subsequently, the pin is allowed to warm to ambient temperature, and this causes the material of the pin 6 to revert to the austenitic crystal structure and to the second memorised shape, as shown in FIG. 2. Thus, the retaining portion 10 bends away from the axis X to lie against the outer surface of the retaining ring 4.

The transition temperature of the material of the pin will depend on the composition of the material. For example, in the example shown in FIGS. 1 and 2, the transition temperature may be below normal ambient temperature, for example below 0° C., in which case the pin 6, once formed in the cold condition into the first, straight, configuration shown in FIG. 1, must be maintained below the transition temperature to enable it to be inserted into the aligned holes in the clevis pin 2 and the retaining ring 4. After insertion, the pin can be allowed to warm up to ambient temperature so that, on passing the transition temperature, it will revert to the second configuration shown in FIG. 2.

The pin 6 in the embodiment of FIGS. 1 and 6 is made, in its entirety, from the shape memory effect alloy. However, it will be appreciated that, in some embodiments, it would be possible for only the retaining portion 10 of the pin 6 to be made of such a material, with the remainder of the pin being made of conventional materials. The two parts of the pin 6 may be mechanically joined, for example by use of a mechanical fixing or mechanical interlock arrangement. Alternatively they may be joined by a suitable adhesive.

In the embodiment of FIGS. 1 and 2, the retaining portion 10 deflects laterally of the longitudinal axis X when transforming to the second memorised configuration. However, it will be appreciated that any shape or size change of the retaining portion 10 which prevents the retaining portion 10 from re-entering the hole in the retaining ring 4 will be sufficient to prevent removal of the pin 6. Various possibilities are shown in FIGS. 3 to 6.

FIG. 3 shows a pin 6 which is in the form of a split cotter pin. In the first memorised configuration, the tangs of the pin are straight and lie against each other. The retaining portion 10 comprises the ends of the tangs of the pin which deform into the second memorised configuration in which they extend in opposite directions over the surface of the retaining ring 4.

FIG. 4 shows an embodiment in which the retaining portion 10 of an unsplit pin 6 can be configured by changing its transverse dimension, in order to prevent withdrawal of the pin 6. In FIG. 4, only the outer surface of the retaining ring 4 is shown. It will be appreciated that a clevis pin 2, or a similar structure having a formation to be retained by the pin 6, will be inserted within the retaining ring 4.

FIGS. 5 and 6 show an embodiment which starts from a first configuration shown in FIG. 5, in which the pin 6 has a straight longitudinal pin axis X, and extends diametrically across the interior of the retaining ring 4. In the second memorised configuration, the retaining portion 10 is deflected away from the axis X, so, again, preventing re-entry of the retaining portion 10 into the holes 12, so that the pin 6 is locked with respect to the retaining ring 4.

FIG. 7 shows a tool for applying retaining elements in the form of the pins shown in FIGS. 1 to 6. The tool is a hand-held tool and comprises a main body 20 having a handle 22. The body 20 is also provided with a removable magazine 24 containing a stock of pins 6 (only three shown in the magazine in FIG. 7). The interior of the magazine, when fitted to the body 20, communicates with a discharge passage 26. As shown in FIG. 7, a pin 6A is present in the discharge passage 26, having been delivered from the magazine 24. Application means in the form of a solenoid 28 is provided in the body 20 for displacing the pin 6A from the discharge passage 26 to apply it to a workpiece 30 (FIG. 11).

The solenoid 28 comprises a stationary coil 32 and a ferromagnetic armature 34 which is movable within the body 20 towards and away from the coil 32. A spring 36 biases the armature 34 away from the coil 32. The armature 34 carries an ejector rod 38 which projects into the discharge passage 26.

The handle 22 accommodates a transformer 40 and control circuitry 42 embodied in a microprocessor. An operating switch 44 is also provided. Mains electricity is provided to the transformer 40 by a lead 46.

The magazine 24 is provided with guide means 48 shown only schematically in FIG. 8, for supporting the pins 6 in a suitable orientation for transfer to the discharge passage 26. A feed mechanism 50 is provided for advancing the pins 6 along the magazine 24 towards the ejection passage 26.

The interior of the magazine 24 comprises a first “cold” region 52 which is provided with temperature control means in the form of cooling elements 56. When supplied with power, the cooling elements 56 maintain the first “cold” region 52 and the pins 6 within it at a temperature in a predetermined range below the transition temperature of the material from which the pins 6 are made. A temperature sensor such as a thermocouple 58 monitors the temperature in the first “cold” region 52 and provides a signal to the microprocessor 42 in order to control the cooling elements 56.

The body 20 has a LED display screen 66 which displays the temperature in the cooled region 52, as measured by the thermocouple 58, and a count of the number of pins 6 that have been dispensed from the ejection passage 26 as counted by the number of actuations of the solenoid 28.

FIG. 10 shows a sectional view of the magazine 24, indicating a possible form for the guide means 48 for a pin 6 of the kind shown in FIGS. 1 and 2, which transforms between a straight configuration 6′ when cold to a bent configuration 6″ when warmed to ambient temperature or above. The guide means 48 thus comprises a recess 60 which is shaped to accommodate the pin 6 in both configurations, while maintaining the pin 6 in a desired orientation as a result of cooperation between a head 62 of the pin and a necked region 64 of the recess 60.

In operation of the tool shown in FIGS. 7 to 11, the magazine 24 is loaded with pins 6 in the ambient temperature configuration 6″ (FIG. 10). When the tool is powered on, the cooling elements 56 are supplied with power and cool the “cold” region 52 of the magazine 24. Any pins 6 in the “cold” region 52 will be cooled from ambient temperature to a temperature below the transition temperature of the material from which the pins are made, and so will transform from the initial bent configuration 6″ (FIG. 10) to the straight configuration 6′. The feed mechanism 50 (shown only diagrammatically in FIG. 7) displaces the pins, in operation, along the guide means 48.

When the cooled region 52 is sufficiently cooled, the pins 6 within it will be in the straight configuration 6′. The cooling element 56 can be positioned so as to cool the region of the body 20 around the discharge passage 26, so as to keep the temperature of a pin 6A in the discharge passage 26 sufficiently low for it to remain in the straight configuration. Alternatively, the cooled pins can be retained in the magazine 24 until required for application to the workpiece 30. For such application, the trigger 44 is depressed, which energises the coil 32, causing the armature 34 to be attracted forwards. This takes with it the rod 38, which acts against the pin 6A to discharge it from the discharge passage 26. This operation is shown in FIG. 11. Once the pin 6A is in place, it will heat to the temperature of the workpiece 30, i.e. to ambient temperature, which will cause the retaining portion 10 of the pin 6 to bend over as shown in FIG. 2. The feed mechanism 50 then operates to advance the pins 6 in the magazine, so delivering the next pin to the discharge passage 26.

Each actuation of the solenoid 28 increases the count on the display screen 66 by one, so that the operator can keep a check on the number of pins 6 that have been applied. In the case of a large assembly, requiring a substantial number of pins 6, this feature provides a useful check that the required number of pins have been installed in the assembly. Also, the temperature displayed on the display screen 66 enables the operator to monitor the temperature of the pins 6 in the magazine 24, so as to ensure that they are at a sufficiently low temperature to remain in the straight condition during the dispensing operation.

It will be appreciated that the guide means 48 can have different shapes to accommodate different types of retaining element. For example, FIGS. 12 to 14 show suitable guide means profiles for the pins 6 shown in FIGS. 3 to 6. As with FIG. 10, the straight configuration of the pin 6 is identified at 6′, while the bent configuration (i.e. the installed configuration) is represented at 6″. In the case of the pin 6 shown in FIG. 14, the “hot/ambient” configuration of the pin 6″ takes the form of an enlarged end, rather than a bend about the axis of the pin. In each case, the guide means 48 provides a recess 60 which can accommodate the pin 6 in both configurations, while locating and orienting the pin 6 in a suitable manner so that it can be delivered from the magazine 24 to the discharge passage 26.

The microprocessor 42 is not only programmed to operate the solenoid 28, the cooling elements 56 and the feed mechanism 50, but also to control the display system 66. In an alternative embodiment, the tool may comprise a hand-held unit substantially in the form of that shown in FIG. 7, and a separate stand-alone unit containing some of the components shown in FIG. 7, for example the microprocessor 42 and the display screen 66. The stand-alone unit may also comprise a power supply including the transformer 40.

Although it has been described that the feed mechanism 50 is solenoid-driven, other feed mechanisms may be used to advance the pins 6 in the magazine. For example, the pins 6 may be spring loaded so that as one pin 6 is used, the next is offered up by the action of the spring. Alternatively, an electric motor could be used to drive the pins which could be attached to a toothed belt.

In an alternative embodiment, the tool may comprise a cordless hand-held unit as shown in FIG. 7, without the lead 46. Such an embodiment would incorporate a battery, for example in the position shown for the transformer 40. Although the power demands of the cooling elements 56 is likely to be substantial, a cordless unit may nevertheless be suitable for the application of relatively small retaining elements 6, particularly if only a small number of the retaining elements 6 can be accommodated in the magazine 24.

The tip of the tool from which the pins 6 are discharged may be adapted to the particular workpiece 30 to which the pins 6 are to be applied. For example, the tip of the tool may be provided with features which assist alignment of the tool with the workpiece 30, for example by engaging the hole 12 into which the pin 6 is to be inserted. Also, the tool may be provided with a safety catch or interlock mechanism, which prevents operation of the solenoid 28 to eject a pin 6 until the tool is in proper contact with the workpiece 30.

The present invention thus provides a tool which enables retaining elements of shape memory effect material to be installed efficiently and accurately. The display 66, which may be a simple LED display, reduces the chance of human error, both in pin count in a particular assembly, and in temperature monitoring of the pins before they are applied to the workpiece. If a separate stand-alone power supply is employed, the tool can be relatively light and ergonomic.

Although it has been described that the pins 6 are used for attaching a clevis pin 2 to a retaining ring 4, it will be appreciated by one skilled in the art that the tool could be used to insert pins 6 into aligned holes of other components so as to secure them together.

1. A tool for applying a retaining element made from a shape memory effect material, the tool comprising application means for applying the retaining element to a workpiece, and a magazine for accommodating the retaining elements prior to application, the magazine being provided with temperature control means for maintaining the retaining element at a temperature within a predetermined range prior to application to the workpiece.

2. A tool as claimed in claim 1, in which the temperature control means comprises a cooling element disposed within the magazine.

3. A tool as claimed in claim 1, in which the magazine has a first region which is subject primarily to temperature control by the temperature control means.

4. A tool as claimed in claim 1, in which a feed mechanism is provided for feeding the retaining element from the magazine to the application means.

5. A tool as claimed in claim 1, in which the application means comprises drive means for displacing the retaining element from the tool.

6. A tool as claimed in claim 5, in which the drive means comprises a solenoid.

7. A tool as claimed in claim 1, in which means is provided for counting retaining elements as they are applied.

8. A tool as claimed in claim 1, in which a temperature sensor is provided which is responsive to the temperature maintained in the magazine by the temperature control means.

9. A tool as claimed in claim 7, in which display means is provided for displaying the retaining element count and/or the temperature.

10. A tool as claimed in claim 1, including a plurality of retaining elements accommodated within the magazine.

11. A tool as claimed in claim 10, in which each retaining element has a first configuration when at a temperature in the predetermined temperature range maintained by the temperature control means, and a second configuration at a temperature outside the predetermined range.

12. A tool as claimed in claim 11, in which each retaining element has the second configuration at ambient temperature.

13. A tool as claimed in claim 11, in which each retaining element is in the form of a pin which is substantially straight in the first configuration, and curved in the second configuration.

14. A tool as claimed in claim 1, which is a hand-held tool.

15. A tool as claimed in claim 14, in which the tool comprises a hand-held unit comprising the application means and the magazine, and a separate monitoring unit in signal communication with the hand-held unit.

16. A tool as claimed in claim 15 in which:
means is provided for counting retaining elements as they are applied, and
display means is provided for displaying the retaining element counted and/or temperature, the display means being provided on the monitoring unit.

17. A tool as claimed in claim 15, in which the monitoring unit is provided with a power supply for the hand-held unit.

18. A method of applying a retaining element using a tool in accordance with claim 1, the retaining element being made from a shape memory effect material, the method comprising:
(i) accommodating the retaining element in the magazine of the tool at a temperature at which the retaining element has a first configuration;
(ii) applying the retaining element to a workpiece, the workpiece being at a temperature at which the retaining element assumes a second configuration.

19. A method as claimed in claim 18, in which the temperature of the workpiece is ambient temperature, and the temperature at which the retaining element is accommodated in the magazine is lower than ambient temperature.
